(19) United States
(12) Patent Application Publication
(10) Pub. No.: US 2005/0093896 A1
(43) Pub. Date: May 5, 2005

(54) Remapping signals

(76) Inventor: Beat Stadelmann, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/702,966

(22) Filed: Nov. 5, 2003

(51) Int. Cl. G09G 5/00

(52) U.S. Cl. 345/904

(57) ABSTRACT

Embodiments of methods, apparatuses, devices, and/or systems for remapping signals are described.

### BACKGROUND

This disclosure is related remapping signals, such as, for example, for a display implementation.

Display technology may include projection displays, OLED (Organic Light-Emitting Diode) displays, plasma displays, cathode ray tube displays, and liquid crystal cell displays, although these are just a few examples of display technology. One issue that arises in connection with displays that employ, for example, pixels includes mapping a character and/or other object to be displayed to the pixels of the display. Techniques for accomplishing this successfully and in a cost effective manner continue to be desirable.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIG. 1 is a schematic diagram illustrating an embodiment of a display system;

FIG. 2 is a plan view illustrating a sample pin out assignment for an embodiment of a driver/MCU for a display;

FIG. 3 is a table illustrating a sample memory organization for the embodiment of FIG. 2;

FIG. 4 is a plan view illustrating an embodiment of a printed circuit board;

FIG. 5 is a table illustrating an embodiment of a remapping of the sample memory organization of FIG. 3;

FIGS. 6A and 6B are schematic diagrams illustrating embodiments of a controller;

FIG. 7 is a schematic diagram illustrating another embodiment of a controller;

FIG. 8 is a schematic diagram illustrating still another embodiment of a controller;

FIG. 9 is a schematic diagram illustrating a simplified embodiment of a portion of a display system;

FIG. 10 is a table illustrating a sample memory organization for the embodiment of FIG. 9; and

FIG. 11 is a table illustrating an embodiment of a remapping of the sample memory organization of FIG. 10.

### DETAILED DESCRIPTION

In the following detailed description, numerous specific details are set forth to provide a thorough understanding of the claimed subject matter. However, it will be understood by those skilled in the art that the claimed subject matter may be practiced without these specific details. In other instances, well-known methods, procedures, components and/or circuits have not been described in detail so as not to obscure the claimed subject matter.

Display technology may include projection displays, OLED (Organic Light-Emitting Diode) displays, plasma displays, cathode ray tube displays, 7-segment displays, and liquid crystal cell displays, although these are just a few examples of display technology. One issue that may arise with displays that employ, for example, pixels includes mapping a character and/or other object to be displayed to the pixels of the display. Techniques for accomplishing this successfully and in a cost effective manner continue to be desirable.

For example, without intending to limit the scope of the claimed subject matter in any way, typically a device or other system, such as a signal driver/controller, for example, may be employed to produce signals to be applied to a particular display, such as, for example, a liquid crystal display (LCD). Furthermore, the signals applied by the signal driver and/or other device may be arranged or devised to result in the display of characters, images and/or other objects by the display device, an LCD in this particular example. It is, of course, appreciated that the claimed subject matter is not limited to the particular devices employed in this display system. These are provided only as illustrative examples. For example, while this embodiment comprises an LCD display, any and all other types of displays currently known or later developed are included within the scope of the claimed subject matter.

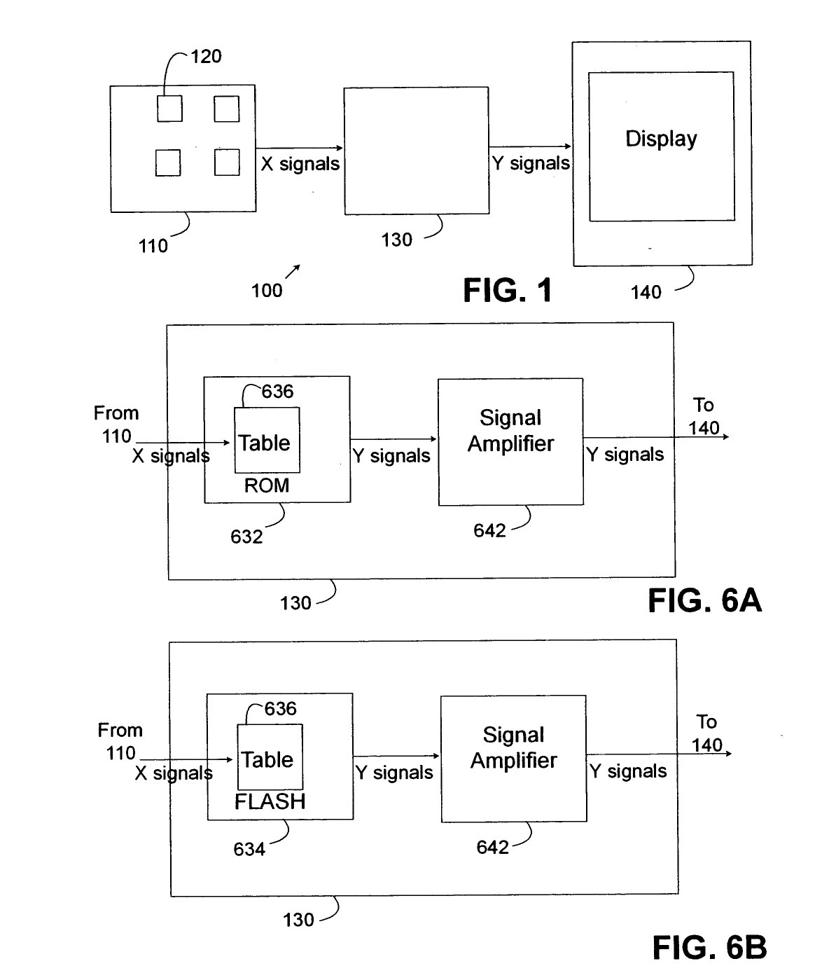

However, continuing with this example, and referring to FIG. 1, in such a system embodiment, such as 100, an input device, such as a keypad or a keyboard 110, for example, may have keys 120, and/or other input components, that are pressed and/or otherwise actuated in some manner to indicate an object to be displayed, for example. Thus, images, characters and/or other objects may be indicated. As a result, the input device may produce electrical signals, for example. It is noted that such signals may also comprise wireless or RF signals, acoustic signals, optical signals and/or any other type of signal.

Regardless of whether the signals are communicated through a wire line or by other techniques, the signals produced by the input device may be applied to another device, such as a controller, a driver and/or the like, including device combinations, such as 130, so that the device may be signaled regarding which characters, images, and/or other objects it is desired to be displayed. Then 130, for example, may produce the appropriate signals to drive a display, such as display 140, for example, and, thereby, the desired characters, images and/or other objects may be produced on the display to be visually perceived.

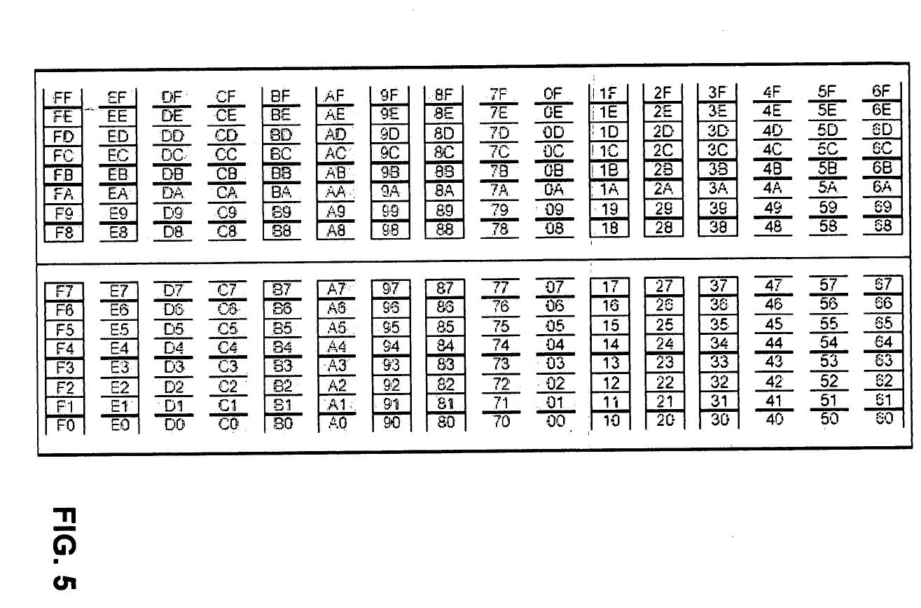

Of course, there are a variety of ways to implement device 130 and the claimed subject matter is not limited in scope to a particular approach. For example, as illustrated in FIGS. 6A and 6B, device 130 may include a read only memory (ROM) 632 or flash memory 634 that operates as a look-up table 636. Thus, device 130 may receive signals from 110, designated as “X signals” in FIGS. 1 and 6A and B. These signals, in one particular embodiment, may operate as addresses for ROM 632 or flash 634, for example. The ROM or flash memory may then provide the contents of the memory locations addressed by the input signals. In FIGS. 6A and B, the contents produced by the ROM or flash memory are designated as “Y signals” and are intended, for this particular embodiment, to correspond to Y signals designated in FIG. 1. Thus, these signals may be applied to display 140. In response to receiving these signals, display 140 may, thus, produce characters, images and/or other objects visually that correspond to keys actuated on input device 110 for this particular embodiment. Of course, device 130 will likely include other circuitry, such as an amplifier, for example, 642 in FIGS. 6A and B, to amplify the signals being applied to display 140 and/or some other circuitry to ensure that the voltages or other electrical signals applied to display 140 are sufficient to produce the desired visual results based at least in part on the operating parameters of display 140. It is, of course, appreciated that the foregoing circuitry need not be embodied on a single chip or integrated circuit (IC). Likewise, the foregoing circuitry may be implemented without employing an IC at all.

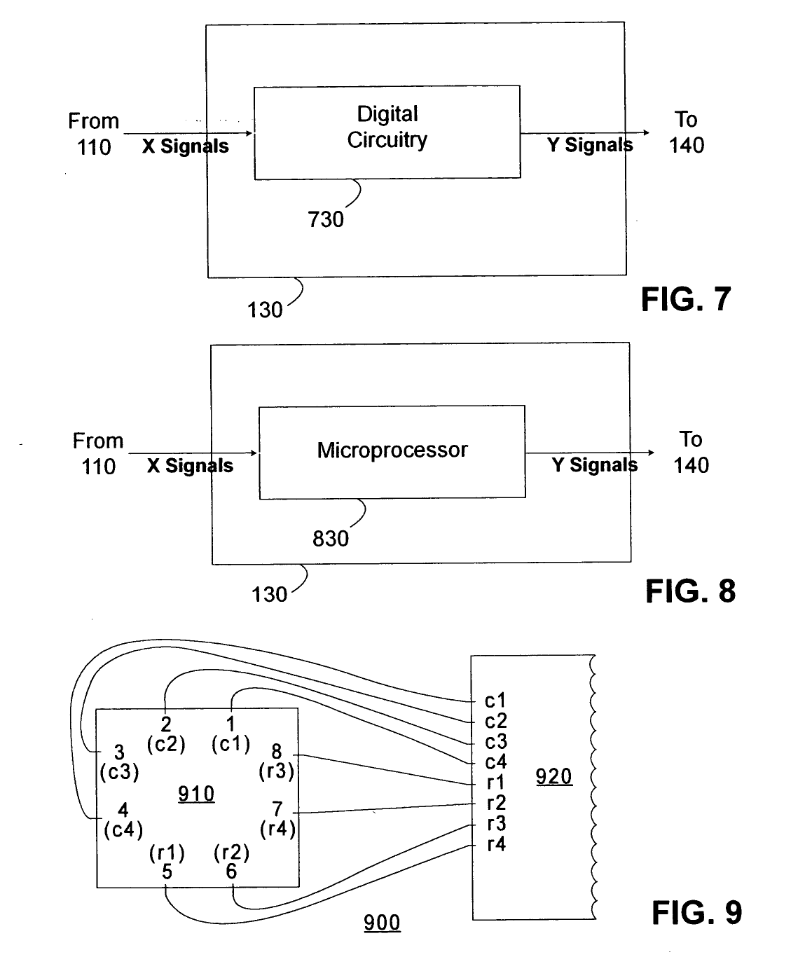

Likewise, other approaches to producing signals to drive a display, such as display 140, may be employed and are included within the scope of the claimed subject matter. For example, instead of employing a look-up table, as illustrated in FIG. 7, digital electronic circuitry, such as 730, may be employed that produces the appropriate output signals to drive display 140 when the appropriate input signals are applied to 130. Any one of a number of digital design techniques may be applied to produce such circuitry, such as, without limitation, the techniques, described in, for example, Digital Logic and Computer Design, by M. Morris Mano, available from Prentice Hall, Inc., Englewood Cliffs, N.J., 1979. Likewise, device 130 may alternately include a microprocessor or other processor, such as illustrated in FIG. 8. Thus, microprocessor 830, for example, may be programmed to produce the desired output signals “on the fly” from input signals applied. For example, an equation or an algorithm may be devised that produces the desired output signals from the corresponding input signals. In general, any technique that may be employed to produce a digital output signal from a digital input signal may be employed in this context.

More specifically, typically the manufacturer of a particular display provides a particular association for the display so that it is known which digital signals, in this particular embodiment, applied to the display will produce particular desired characters, images, and/or other objects to appear visually on the display. Of course, the claimed subject matter is not limited in scope to only employing digital signals. More specifically, however, as one example, a row and column location may be associated with a pixel location on the display. Thus, signals may be applied to the display corresponding to a particular row and column location so that particular pixels are illuminated.

The manufacturer or another entity may have either designed or worked out a correspondence between signals applied to the display and the pixel locations to be illuminated. Thus, a device, such as an integrated circuit chip, may be provided that has stored digital content at particular memory locations. Likewise, applying signals to particular pins of such an IC may call up or produce that content on output pins of the device. Thus, a particular character, image, and/or other object may be produced by calling up content in a particular order or sequence. That is, by applying signals to an IC, in this example, in a particular sequence, the digital content of particular memory locations may be produced. That content, when applied to a display, may then result in the illumination of particular pixels on the display to produce the desired images, characters and/or other objects. Of course, as indicated above, it is not necessary that an IC be employed and an IC is merely mentioned as a possible embodiment.

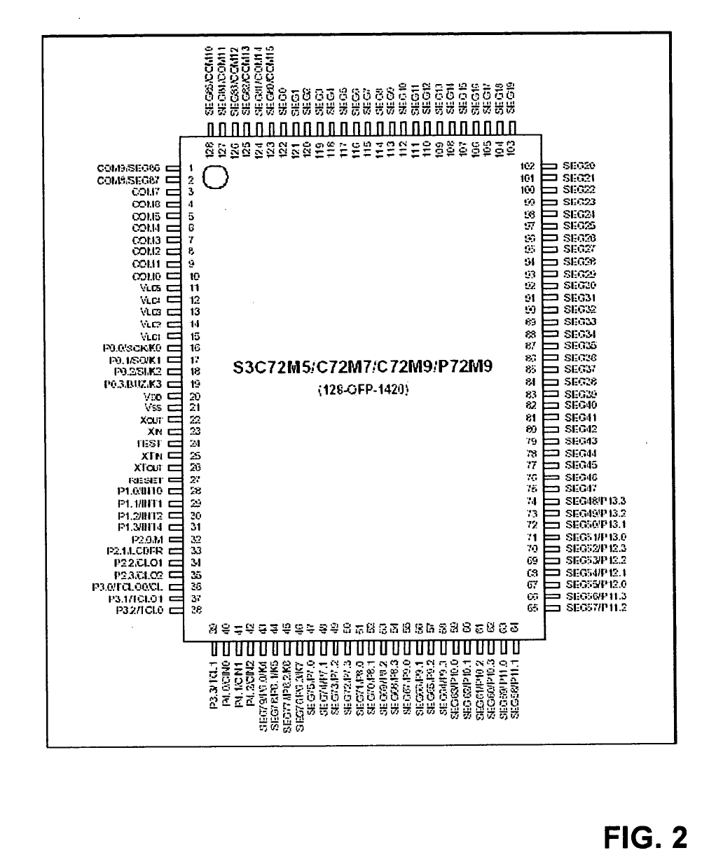

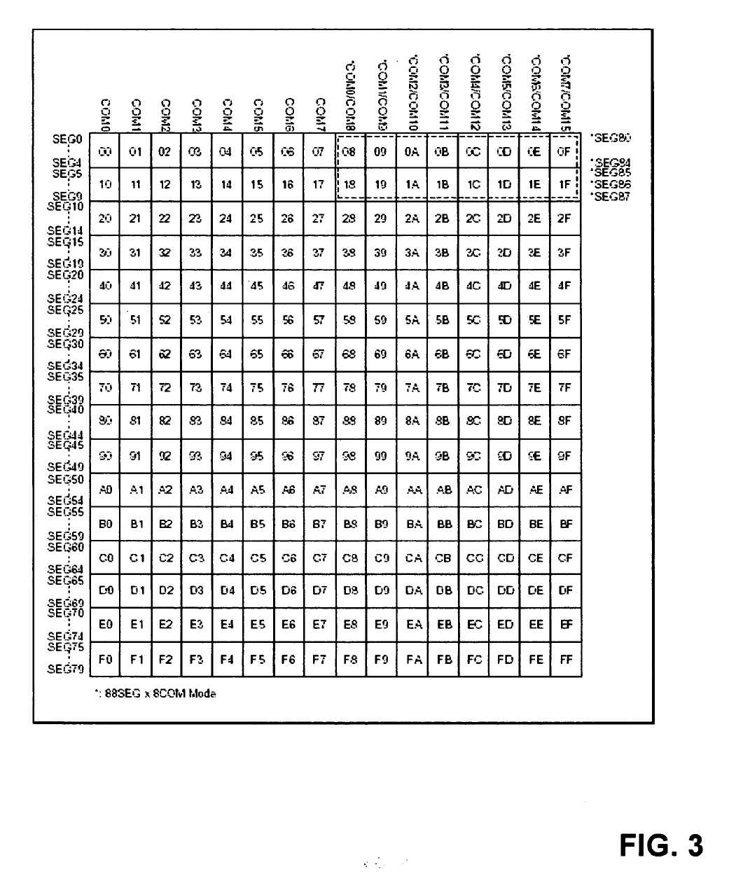

For example, FIG. 2 illustrates the pin assignment and FIG. 3 illustrates the memory map for an LCD driver product available from Samsung Semiconductor, the S3C72M9, embodied on an IC. Thus, here, Samsung has indicated that for this product the following sequence of binary digital signals or bits will produce an “F” character if the output signals of the IC shown in FIG. 2 are applied to a display: 1FH, 01H, 01H, 0FH, 01H, 01H, 01H, where H denotes hexadecimal. As indicated by FIG. 3, if this content is read from a memory of device 130, for example, in accordance with the memory map shown in FIG. 3, for example, the following sequence of pins shown in FIG. 2 will produce signals to be a applied to a display, such as display 140, and result in the illumination of pixels at the designated row and column locations: pins 117-113, pin 123 (seg5-seg9, com15); pins 112-118, pin 9 (seg0-seg4, com1); pins 112-118, pin 9 (seg0-seg4, com1); pins 112-118, pin 123 (seg0-seg4, com15); pins 112-118, pin 9 (seg0-seg4, com1); pins 112-118, pin 9 (seg0-seg4,com1); pins 112-118, pin 9 (seg0-seg4, com1). As indicated by FIG. 2, applying voltage signals to the IC shown in FIG. 2 will, therefore, produce the desired digital content of the illustrated memory map as output signals of the IC that may be applied to the display, resulting in the desired “F” character visually appearing on the display itself.

In such an implementation as this, then, the memory locations contain the appropriate signals to read out and apply to the display to drive or illuminate particular pixel locations of the display, in this example. Thus, in this particular embodiment, device 130 may receive signals from input device 110 indicating a particular object or objects to be displayed. Device 130 may then produce signals to drive a display, such as display 140, so that the desired object or objects indicated by the signals from device 110 are produced on display 140. As the previous discussion, therefore, illustrates, a device, such as 130, or such as illustrated in FIG. 2, translates signals, such as X signals in FIG. 1, from an input device, such as 110, into signals, such as Y signals in FIG. 1, to drive a display, such as 140.

For high production environments, however, a printed circuit board (PCB) may be employed to make desired connections to a display, such as to 140, in this example. In this embodiment, “connection” refers to an electrical connection, although optical, acoustic, and/or wireless connections may alternately be employed in other embodiments. Where a PCB is employed, such an approach may be cost effective in that it does not require a technician or other professional to “wire” or otherwise connect the controller and/or driver circuitry for every unit being manufactured. Instead, PCBs are printed with the desired connections and an assembly line worker, for example, may be employed to connect the controller/driver, display, and/or other components to the PCB.

Of course, as some may appreciate, particularly from FIGS. 2 and 3, the number of different pins for a device to drive an LCD or other display device may be quite large. Furthermore, depending on the layout of the LCD, or other display device, the layout of the controller/driver, and/or the complexity of the signaling, it may prove difficult to employ a PCB having a single layer to make all or even a substantial portion of the desired connections. For example, some traces may cross one another, making a multi-layer PCB desirable in such a situation. In this context, a trace refers to an electrical connection on a PCB, typically accomplished using conductive material, such as metal. Unfortunately, however, the more PCB layers or levels employed, the greater the expense.

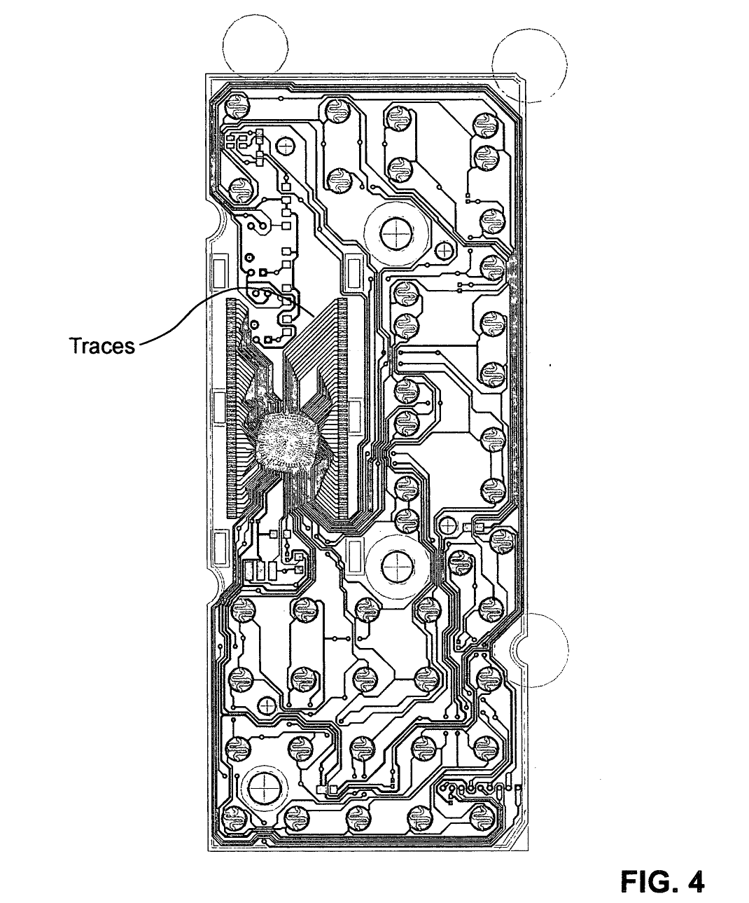

One approach to avoid a multi-layer PCB or to at least reduce the number of layers or levels may be to layout the connections between the controller or other driver circuitry and the display so that traces do not cross, or at least so that fewer of the connections cross than otherwise would occur from following the provided pin out or port assignment provided by a supplier or manufacturer. FIG. 4, for example, illustrates a PCB where no traces cross. Of course, this is just an example, and, instead, some traces may cross, but it is desirable to have fewer than otherwise would cross if the pin assignment provided were employed, for example. Of course, in alternative embodiments, the connections to be arranged may be between another type of circuitry other than a controller or a driver and another type of device other than a display. Likewise, as previously indicated, the connections may involve a type of signal other than an electrical signal. However, continuing with this example, if it is possible to physically lay out the connections so that traces do not cross, or so that fewer traces cross, then fewer PCB layers may be employed, or even a one layer PCB may be employed, as illustrated in FIG. 4, making production more cost effective.

However, assuming that the circuitry for the display or other device, such as pin assignments, for example, may not be modified, having no traces cross, or having fewer traces cross, may potentially produce a set of connections, such as between the display and circuitry to drive the display, in which the images, characters and/or other objects that are displayed appear other than as desired. That is, referring to FIG. 1, for example, pressing or actuating keys of an input device may not produce the characters, images, or other objects desired. The characters or other objects might, for example, appear upside down, backwards, or in some other undesired manner, depending on the resulting connections. Likewise, depending on the digital content, perhaps entirely different characters, images and/or other objects than desired appear as a result.

In this embodiment, however, in which a layout is employed with no traces crossing, or with fewer traces crossing, but that likewise results in characters and/or objects appearing on the display other than as desired, the memory maps, here bit maps, that produce those objects, typically stored by a controller, for example, may be adjusted so that, when displayed, the objects appear properly and/or the objects that are desired appear. For example, if the connections were to produce a backwards image on the display, then, a bit map may be stored backwards so that when produced on the display, it appears as desired. Thus, in this particular embodiment, a memory map of the bits is remapped so as to correct for anomalies, such as, for example, translations, rotations, and/or reflections, that otherwise would result from display of the memory map without having performed a remapping. Likewise, if the wrong object appears, then digital content of particular locations may be interchanged so that the desired object appears.

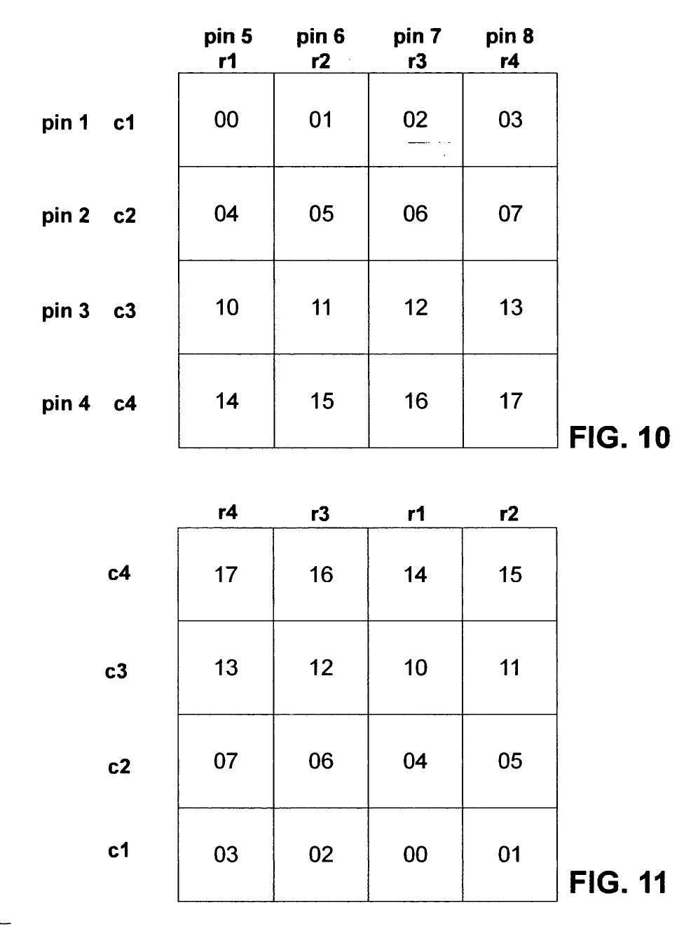

This is perhaps illustrated effectively with a simple example. FIG. 9 illustrates an embodiment 900 of an IC 910 directly coupled to the input ports of a display 920. Not specifically shown here are the pins to drive the IC to produce output signals on the pins illustrated here. In this example, however, IC 910 includes 8 output pins, numbered 1 to 8, directly coupled to eight input ports. FIG. 9 also provides the correspondence between the signals on the output pins of IC 910 and the addressing of the rows and columns of display 920. FIG. 10 illustrates an embodiment of a memory map to produce signals on the output pins of IC 920. However, FIG. 9 also illustrates that the output pins of IC 910 are not coupled to the appropriately corresponding input ports of display 920. In this example, this is done so that the couplings or connections illustrated do not cross. Thus, when IC 910 receives signals to provide the contents of location 00, instead of pixel r1, c1 being illuminated, as indicated by the memory map embodiment of FIG. 10, instead, pixel c4, r4 will be illuminated. FIG. 11, therefore, illustrates a remapping of the memory map embodiment of FIG. 10, so that the desired pixels will be illuminated as intended. Thus, for the example above, despite the coupling shown in FIG. 9, using the memory map of FIG. 11, when IC 910 receives signals to provide the contents of location 00, pixel r1, c1 will be illuminated.

Referring now, to the embodiment employing the signal driver/controller available from Samsung, FIG. 5 likewise illustrates a new memory map or remapped memory for the previously referenced driver having the memory organization illustrated in FIG. 3. In this table, the value of an address that is lighter is backwards in comparison with FIG. 3. The darker values are not backwards. Thus, for the PCB layout illustrated in FIG. 4, to produce the desired objects or characters, the memory map of FIG. 5 is employed; however, this is to adjust or correct for connections between the driver and display that would otherwise produce an anomalous image, character and/or object without this particular remapping.

A comparison of FIG. 3 and FIG. 5 reveals the relationship between the two maps. There are a number of ways to view the operations applied to FIG. 3 that might produce FIG. 5 since there are symmetries, such as communicative and associative properties. The claimed subject matter is, of course, not limited to a particular set of operations or a particular order in which they may be applied. Here, however, the embodiment of FIG. 5 may be viewed as a rotation of 90 degrees (rotation), followed by the first 7 columns being interchanged with the second 9 columns (translation), followed by the first 9 columns being reversed (reflection).

It is, of course, appreciated that the claimed subject matter is not limited in scope to an embodiment in which the memory maps, here bit maps, are stored by a controller or a driver. In an embodiment, the bit maps may be stored anywhere within the system and remain within the scope of the claimed subject matter. Likewise, as previously described, rather than storing the content, it may be produced on the fly or by digital logic. In such embodiment changing the digital content produced may involve changing the digital logic or changing the process applied to the input signals where a microprocessor, for example, is employed. In this context, this process, whether applied to a memory or other instantiation is referred to as “remapping” the signals. Here, remapping will typically be applied to binary digital signals or bits, although, of course, the claimed subject matter is not limited in scope in this respect.

It is, of course, now appreciated, based at least in part on the foregoing disclosure, that software may be produced capable of producing the desired remapping. It will, of course, also be understood that, although particular embodiments have just been described, the claimed subject matter is not limited in scope to a particular embodiment or implementation. For example, one embodiment may be in hardware, such as implemented to operate on a device or combination of devices as previously described, for example, whereas another embodiment may be in software. Likewise, an embodiment may be implemented in firmware, or as any combination of hardware, software, and/or firmware, for example. Likewise, although the claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with the claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, the claimed subject matter is not limited in scope to this example.

In the preceding description, various aspects of the claimed subject matter have been described. For purposes of explanation, specific numbers, systems and configurations were set forth to provide a thorough understanding of the claimed subject matter. However, it should be apparent to one skilled in the art having the benefit of this disclosure that the claimed subject matter may be practiced without the specific details. In other instances, well-known features were omitted or simplified so as not to obscure the claimed subject matter. While certain features have been illustrated and described herein, many modifications, substitutions, changes and equivalents will now occur to those skilled in the art. It is, therefore, to be understood that the appended claims are intended to cover all such modifications and changes as fall within the true spirit of the claimed subject matter.

1. A method comprising:
remapping signals so as to correct for anomalies that would otherwise result from displaying said signals without remapping, said anomalies being a result of connecting ports of a display to a signal driver so that fewer connections to said ports cross than otherwise.

2. The method of claim 1, wherein said fewer connections to said ports cross than otherwise comprises no connections to said ports cross.

3. The method of claim 1, and further comprising:
connecting ports of said display to said signal driver so that fewer of said connections to said ports cross than otherwise.

4. The method of claim 3, and further comprising:
connecting ports of said display to said signal driver so that no connections to said ports cross.

5. The method of claim 4, wherein said connections comprise traces on a printed circuit board.

6. The method of claim 1, wherein said signals comprise a memory map stored by said signal driver.

7. The method of claim 6, wherein said memory map comprises bit maps.

8. The method of claim 7, wherein said bit maps comprise character bit maps.

9. The method of claim 1, wherein said display comprises a liquid crystal display.

10. The method of claim 1, wherein said signal driver comprises a controller.

11. The method of claim 10, wherein said controller comprises a microprocessor.

12. The method of claim 10, wherein said controller comprises digital electronic circuitry.

13. The method of claim 1, wherein said connections comprise traces on a printed circuit board (PCB).

14. A method comprising:
remapping a memory map so as to correct for anomalies that would otherwise result from displaying said memory map without remapping, said anomalies being a result of connecting ports of a display to a signal driver so that no connections to said ports cross.

15. The method of claim 14, wherein said memory map comprises bit maps.

16. The method of claim 14, and further comprising:
connecting ports of said display to said signal driver so no connections to said ports cross.

17. The method of claim 14, wherein said connections comprise traces on a printed circuit board.

18. A method comprising:
remapping a memory map of bits so as to correct for anomalies that would otherwise result from displaying said memory map of bits without remapping, said anomalies being a result of connecting ports of an LCD display to a signal driver so that no connections to said ports cross.

19. The method of claim 18, and further comprising:
connecting ports of said display to said signal driver so that no connections to said ports cross.

20. The method of claim 18, wherein said connections comprise traces on a printed circuit board.

21. A method comprising:
connecting ports of a display to a signal driver so that no connections to said ports cross, said signal driver including a memory map of bits to be displayed; and
remapping a memory map of bits so as to correct for one or more translations, rotations, and/or reflections that would otherwise result from displaying said memory map of bits without remapping, said one or more translations, rotations, and/or reflections being a result of connecting ports of a display to a signal driver so that no connections to said ports cross.

22. The method of claim 21, wherein said display comprises a liquid crystal display.

23. The method of claim 21, wherein said signal driver comprises a controller.

24. The method of claim 23, wherein said controller comprises a microprocessor.

25. The method of claim 23, wherein said controller comprises digital electronic circuitry.

26. The method of claim 21, wherein said bit maps comprise character bit maps.

27. The method of claim 21, wherein said connections comprise traces on a printed circuit board (PCB).

28. An apparatus comprising:
a display;
a display driver; and
an input device adapted to provide signals to said device driver;
wherein said display driver includes a capability to produce signals to be displayed based, at least in part, on the signals provided by said input device;
said display driver being connected to the ports of said display so that no connections cross;
said signals to be displayed having been remapped so as to correct for anomalies from displaying said signals to be displayed that would otherwise result without remapping, said anomalies being a result of connecting said ports of said display to said signal driver so that no connections to said ports cross.

29. The apparatus of claim 28, wherein said display comprises a liquid crystal display.

31. The apparatus of claim 28, wherein said signals to be displayed comprise bit maps.

32. The apparatus of claim 28, wherein said connections comprise traces on a printed circuit board (PCB).

33. The apparatus of claim 32, wherein said PCB comprises a one layer PCB.

34. An article comprising:
a storage medium having stored thereon instructions, that when executed, result in performance of a method comprising:
remapping signals so as to correct for anomalies that would otherwise result from displaying said signals without remapping, said anomalies being a result of connecting ports of a display to a signal driver so that fewer connections to said ports cross than otherwise.

35. The article of claim 34, wherein said instructions, when executed, result in: remapping signals so as to correct for anomalies that would otherwise result from displaying said signals without remapping, said anomalies being a result of connecting ports of a display to a signal driver so that no connections to said ports cross.

36. The article of claim 35, wherein said display comprises a liquid crystal display.

37. The article of claim 35, wherein said signal driver comprises a controller.

38. The article of claim 37, wherein said controller comprises a microprocessor.

39. The article of claim 38, wherein said controller comprises digital electronic circuitry.

40. The article of claim 35, wherein said signals comprise bit maps stored on said signal driver.

41. The article of claim 35, wherein said connections comprise traces on a printed circuit board (PCB).

42. A circuit comprising:
digital electronic components being coupled so as to remap signals so as to correct for anomalies that would otherwise result from displaying said signals without remapping, said anomalies being a result of connecting ports of a display to a signal driver so that no connections to said ports cross.

43. The circuit of claim 42, wherein said display comprises a liquid crystal display.

44. The circuit of claim 42, wherein said signal driver comprises a controller.

45. The circuit of claim 42, wherein said connections comprise traces on a printed circuit board (PCB).

46. The circuit of claim 42, wherein said circuit comprises an integrated circuit chip.

47. A circuit comprising:
means for remapping a memory so as to correct for anomalies that would otherwise result from displaying said memory without remapping, said anomalies being a result of connecting ports of a display to a signal driver so that fewer connections to said ports cross than otherwise; and
a memory coupled to said means for remapping.

48. The circuit of claim 47, wherein said display comprises a liquid crystal display.

49. The circuit of claim 47, wherein said signal driver comprises a controller.

50. The circuit of claim 47, wherein said memory comprises bit maps.

51. The circuit of claim 47, wherein said connections comprise traces on a printed circuit board (PCB).

52. The circuit of claim 47, wherein said circuit comprises an integrated circuit chip.

53. A circuit comprising:
means for remapping signals so as to correct for anomalies that would otherwise result from displaying said signals without remapping, said anomalies being a result of connecting ports of a display to a signal driver so that fewer connections to said ports cross than otherwise.

54. The circuit of claim 53, wherein said display comprises a liquid crystal display.

55. The circuit of claim 53, wherein said signal driver comprises a controller.

56. The circuit of claim 53, wherein said signals comprises bit maps.

57. The circuit of claim 53, wherein said connections comprise traces on a printed circuit board (PCB).

58. The circuit of claim 53, wherein said circuit comprises an integrated circuit chip.
